(19) United States
(12) Patent Application Publication
(10) Pub. No.: US 2024/0047680 A1
(43) Pub. Date: Feb. 8, 2024

(54) POSITIVE ELECTRODE MATERIAL AND BATTERY

(71) Applicant: Panasonic Intellectual Property Management Co., Ltd., Osaka (JP)

(72) Inventors: Yumi MIYAMOTO, Osaka (JP); Yoshimasa NAKAMA, Osaka (JP)

(21) Appl. No.: 18/485,999

(22) Filed: Oct. 12, 2023

Related U.S. Application Data
(63) Continuation of application No. PCT/JP2022/001202, filed on Jan. 14, 2022.

(30) Foreign Application Priority Data
Apr. 20, 2021 (JP) 2021-071447

(51) Int. Cl. H01M 4/62; H01M 4/36; H01M 4/505; H01M 4/525; H01M 10/0562; H01M 10/0585

(52) U.S. Cl. CPC H01M 4/62; H01M 4/366; H01M 4/505; H01M 4/525; H01M 10/0562; H01M 10/0585; H01M 2004/028

(57) ABSTRACT

A positive electrode material of the present disclosure includes: a positive electrode active material; a first solid electrolyte material coating at least partially a surface of the positive electrode active material; and a second electrolyte material. The positive electrode active material includes an oxide consisting of Li, Ni, Mn, and O. The first solid electrolyte material includes Li, Ti, M1, and F. The M1 is at least one selected from the group consisting of Ca, Mg, Al, Y, and Zr.

This application is a continuation of PCT/JP2022/001202 filed on Jan. 14, 2022, which claims foreign priority of Japanese Patent Application No. 2021-071447 filed on Apr. 20, 2021, the entire contents of both of which are incorporated herein by reference.

### BACKGROUND OF THE INVENTION

### 1. Field of the Invention

The present disclosure relates to a positive electrode material and a battery.

### 2. Description of Related Art

WO 2019/146216 A1 discloses an all-solid-state battery using a positive electrode material in which a positive electrode active material containing nickel, cobalt, and manganese has a surface at least partially coated with lithium niobate.

### SUMMARY OF THE INVENTION

The present disclosure provides a positive electrode material that enhances the charge and discharge capacity of a battery.

A positive electrode material of the present disclosure includes: a positive electrode active material; a first solid electrolyte material coating at least partially a surface of the positive electrode active material; a second electrolyte material. The positive electrode active material includes an oxide consisting of Li, Ni, Mn, and O. The first solid electrolyte material includes Li, Ti, M1, and F. The M1 is at least one selected from the group consisting of Ca, Mg, Al, Y, and Zr.

The present disclosure provides a positive electrode material that enhances the charge and discharge capacity of a battery.

### BRIEF DESCRIPTION OF THE DRAWINGS

FIG. 1 is a cross-sectional view schematically showing the configuration of a positive electrode material 1000 of Embodiment 1.

FIG. 2 is a cross-sectional view schematically showing the configuration of a battery 2000 of Embodiment 2.

FIG. 3 is a cross-sectional view schematically showing the configuration of a battery 3000 of Embodiment 3.

### DETAILED DESCRIPTION

(Findings on which the Present Disclosure is Based)

WO 2019/146216 A1 discloses an all-solid-state battery using a positive electrode material including: a positive electrode active material containing nickel, cobalt, and manganese; a coating material coating at least partially the surface of the positive electrode active material; and a halide solid electrolyte material. The coating material coating the surface of the positive electrode active material is a solid electrolyte material, and the solid electrolyte material is lithium niobate.

As for positive electrode materials including halide solid electrolytes, studies have been conventionally made on the resistance of such halide solid electrolytes to oxidative decomposition. Halide solid electrolytes are materials containing, as an anion, a halogen element, such as fluorine (i.e., F), chlorine (i.e., Cl), bromine (i.e., Br), or iodine (i.e., I).

The present inventors discovered the following problem with a battery in which a positive electrode material includes a halide solid electrolyte containing at least one element selected from the group consisting of chlorine, bromine, and iodine. Specifically, during charge of the battery, the halide solid electrolyte is oxidatively decomposed and the resulting oxidative decomposition product serves as a resistance layer. This increases the internal resistance of the battery during charge. The present inventors inferred that the cause is an oxidation reaction of the at least one element, which is selected from the group consisting of chlorine, bromine, and iodine contained in the halide solid electrolyte. Here, the oxidation reaction refers to a side reaction that occurs in addition to a normal charge reaction in which lithium and electrons are extracted from the positive electrode active material included in the positive electrode material. In the side reaction, electrons are extracted even from the halide solid electrolyte containing the at least one element in contact with the positive electrode active material, which is selected from the group consisting of chlorine, bromine, and iodine. It is considered that this oxidation reaction forms, between the positive electrode active material and the halide solid electrolyte, an oxidative decomposition layer having a poor lithium-ion conductivity and serving as a high interfacial resistance in an electrode reaction of the positive electrode. It is considered that chlorine, bromine, and iodine are prone to be oxidized because of having a relatively large ionic radius and a small interaction force with a cationic component of the halide solid electrolyte. This problem is more prone to occur in the case where a positive electrode active material having a potential of more than 3.9 V versus Li is used than in the case where a positive electrode active material having a potential of 3.9 V or less versus Li is used. It is known that decomposition of the solid electrolyte occurs not only in the case where a halide solid electrolyte is used but also in the case where, for example, a sulfide solid electrolyte is used.

WO 2019/146216 A1 discloses a battery including a positive electrode layer including: a positive electrode active material coated with lithium niobate; and a halide solid electrolyte. Such coating of a positive electrode active material with a coating material can suppress formation of an oxidative decomposition layer due to a halide solid electrolyte to suppress an increase in internal resistance, thereby suppressing a decrease in the charge and discharge capacity of a battery.

As for positive electrode materials including a coated positive electrode active material, the present inventors intensively studied configuration in which a decrease in the charge and discharge capacity of a battery can be further suppressed. As a result, the present inventors elucidated that it is possible to further suppress a decrease in the charge and discharge capacity of a battery in which a positive electrode active material includes an oxide consisting of Li, Ni, Mn, and O, and the positive electrode active material has a surface coated with a solid electrolyte material including Li, Ti, M1, and F, where M1 is at least one selected from the group consisting of Ca, Mg, Al, Y, and Zr.

On the basis of the above findings, the present inventors have arrived at the following positive electrode material of the present disclosure.

The positive electrode material of the present disclosure has a structure in which: a positive electrode active material, a first solid electrolyte material, and a second electrolyte material are included; the positive electrode active material includes an oxide consisting of Li, Ni, Mn, and O; the first solid electrolyte material coats at least partially a surface of the positive electrode active material and includes Li, Ti, M1, and F; and the M1 is at least one selected from the group consisting of Ca, Mg, Al, Y, and Zr. With this configuration, the positive electrode material of the present disclosure has an enhanced oxidation resistance, and therefore can enhance the charge and discharge capacity of a battery.

### (Outline of One Aspect According to the Present Disclosure)

A positive electrode material according to a first aspect of the present disclosure includes: a positive electrode active material; a first solid electrolyte material coating at least partially a surface of the positive electrode active material; and a second electrolyte material, wherein the positive electrode active material includes an oxide consisting of Li, Ni, Mn, and O, the first solid electrolyte material includes Li, Ti, M1, and F, and the M1 is at least one selected from the group consisting of Ca, Mg, Al, Y, and Zr.

In the positive electrode material according to the first aspect, the positive electrode active material having the surface at least partially coated with the first solid electrolyte material has a high oxidation resistance. Therefore, it is possible to suppress a decrease in charge and discharge capacity due to oxidative decomposition of the second electrolyte material in the positive electrode material.

In a second aspect of the present disclosure, for example, in the positive electrode material according to the first aspect, the positive electrode active material may include a material represented by the following composition formula (1)

LiNiₓMn₂₋ₓO₄ Formula (1), and

the composition formula (1) satisfies 0<x<2.

The positive electrode material according to the second aspect can enhance the charge and discharge capacity of a battery.

In a third aspect of the present disclosure, for example, in the positive electrode material according to the second aspect, the composition formula (1) may satisfy 0<x<1.

The positive electrode material according to the third aspect can enhance the charge and discharge capacity of a battery.

In a fourth aspect of the present disclosure, for example, in the positive electrode material according to the third aspect, the composition formula (1) may satisfy x=0.5.

The positive electrode material according to the fourth aspect can enhance the charge and discharge capacity of a battery.

In a fifth aspect of the present disclosure, for example, in the positive electrode material according to any one of the first to fourth aspects, the first solid electrolyte material may consist of Li, Ti, M1, and F.

In the positive electrode material according to the fifth aspect, the first solid electrolyte material exhibits a high ionic conductivity. Consequently, in the positive electrode material, a low interfacial resistance between the first solid electrolyte material and the positive electrode active material can be achieved. Therefore, the positive electrode material can enhance the charge and discharge capacity of a battery.

In a sixth aspect of the present disclosure, for example, in the positive electrode material according to any one of the first to fifth aspects, the first solid electrolyte material may include a material represented by the following composition formula (2B)

Li_{6-(4-a)b}(Ti₁₋ₐM1ₐ)_{b}F₆ Formula (2B), and

the composition formula (2B) satisfies 0<a<1 and 0<b≤1.5.

In the positive electrode material according to the sixth aspect, the first solid electrolyte material exhibits a high ionic conductivity. Consequently, in the positive electrode material, a low interfacial resistance between the first solid electrolyte material and the positive electrode active material can be achieved. Therefore, the positive electrode material can enhance the charge and discharge capacity of a battery.

In a seventh aspect of the present disclosure, for example, in the positive electrode material according to any one of the first to sixth aspects, the M1 may be Al.

Al is inexpensive and suitable as an element for enhancing the ionic conductivity of an electrolyte. Accordingly, in the positive electrode material according to the seventh aspect, the first solid electrolyte material exhibits a higher ionic conductivity. Consequently, in the positive electrode material, a lower interfacial resistance between the first solid electrolyte material and the positive electrode active material can be achieved. Therefore, the positive electrode material can enhance the charge and discharge capacity of a battery.

In an eighth aspect of the present disclosure, for example, in the positive electrode material according to any one of the first to seventh aspects, the second electrolyte material may include: Li; at least one selected from the group consisting of metalloid elements and metal elements except Li; and at least one selected from the group consisting of Cl and Br.

The positive electrode material according to the eighth aspect can enhance the charge and discharge capacity of a battery.

In a ninth aspect of the present disclosure, for example, in the positive electrode material according to the eighth aspect, the second electrolyte material may include a material represented by the following composition formula (3)

Li_{α3}M2_{β3}X_{γ3}O_{δ3} Formula (3),

where α3, β3, and γ3 are each a value greater than 0, and δ3 is a value equal to or greater than 0,

M2 is at least one selected from the group consisting of metalloid elements and metal elements except Li, and

X is at least one selected from the group consisting of Cl and Br.

In the positive electrode material according to the ninth aspect, the ionic conductivity of the second electrolyte material can be further enhanced. Therefore, resistance derived from migration of Li ions in the positive electrode material can be further reduced, thereby more effectively suppressing an increase in the internal resistance of a battery during charge.

In a tenth aspect of the present disclosure, for example, in the positive electrode material according to the ninth aspect, the M2 may include at least one selected from the group consisting of Y and Ta.

In the positive electrode material according to the tenth aspect, the ionic conductivity of the second electrolyte material can be further enhanced. Therefore, resistance derived from migration of Li ions in the positive electrode material can be further reduced, thereby more effectively suppressing an increase in the internal resistance of a battery during charge.

In an eleventh aspect of the present disclosure, for example, in the positive electrode material according to the ninth or tenth aspect, the composition formula (3) may satisfy:

1≤α3≤4;

0<β3≤2;

3≤γ3<7; and

0≤δ3≤2.

In the positive electrode material according to the eleventh aspect, the ionic conductivity of the second electrolyte material can be further enhanced. Therefore, resistance derived from migration of Li ions in the positive electrode material can be further reduced, thereby more effectively suppressing an increase in the internal resistance of a battery during charge.

In a twelfth aspect of the present disclosure, for example, in the positive electrode material according to any one of the first to eleventh aspects, the second electrolyte material may include a sulfide solid electrolyte.

In the positive electrode material according to the twelfth aspect, the ionic conductivity of the second electrolyte material can be further enhanced. Therefore, resistance derived from migration of Li ions in the positive electrode material can be further reduced, thereby more effectively suppressing an increase in the internal resistance of a battery during charge.

In a thirteenth aspect of the present disclosure, for example, in the positive electrode material according to the twelfth aspect, the sulfide solid electrolyte may be Li₆PS₅Cl.

In the positive electrode material according to the thirteenth aspect, the ionic conductivity of the second electrolyte material can be further enhanced. Therefore, resistance derived from migration of Li ions in the positive electrode material can be further reduced, thereby more effectively suppressing an increase in the internal resistance of a battery during charge.

In a fourteenth aspect of the present disclosure, for example, in the positive electrode material according to any one of the first to thirteenth aspects, the first solid electrolyte material may be provided between the positive electrode active material and the second electrolyte material.

In the positive electrode material according to the fourteenth aspect, since the first solid electrolyte material having a high oxidation resistance is interposed between the positive electrode active material and the second electrolyte material, oxidative decomposition of the second electrolyte material can be suppressed, thereby suppressing an increase in the internal resistance of a battery during charge.

A battery according to a fifteenth aspect of the present disclosure includes:
a positive electrode;
a negative electrode; and
an electrolyte layer positioned between the positive electrode and the negative electrode, wherein
the positive electrode includes the positive electrode material according to any one of the first to fourteenth aspects.

In the battery according to the fifteenth aspect, an increase in the internal resistance of the battery during charge is suppressed, thereby enhancing the charge and discharge capacity.

In a sixteenth aspect of the present disclosure, for example, in the battery according to the fifteenth aspect, the electrolyte layer may include a first electrolyte layer and a second electrolyte layer, and
the first electrolyte layer may be in contact with the positive electrode, and the second electrolyte layer may be in contact with the negative electrode.

In the battery according to the sixteenth aspect, an increase in the internal resistance of the battery during charge is suppressed, thereby enhancing the charge and discharge capacity.

In a seventeenth aspect of the present disclosure, for example, in the battery according to the sixteenth aspect, the first electrolyte layer may include a material having the same composition as composition of the first solid electrolyte material.

The battery according to the seventeenth aspect has an enhanced charge and discharge capacity.

In an eighteenth aspect of the present disclosure, for example, in the battery of the sixteenth aspect, the first electrolyte layer may include a material having the same composition as composition of the second electrolyte material.

The battery according to the eighteenth aspect has an enhanced charge and discharge capacity.

In a nineteenth aspect of the present disclosure, for example, in the battery according to the sixteenth aspect, the second electrolyte layer may include a material having composition different from composition of the first solid electrolyte material.

The battery according to the nineteenth aspect has an enhanced charge and discharge capacity.

In a twentieth aspect of the present disclosure, for example, in the battery according to the fifteenth aspect, the electrolyte layer may include a halide solid electrolyte.

The battery according to the twentieth aspect has an enhanced charge and discharge capacity.

Embodiments of the present disclosure will be described below with reference to the drawings.

### Embodiment 1

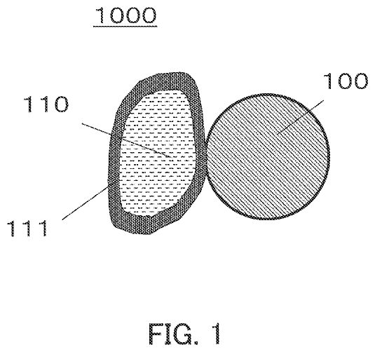

FIG. 1 is a cross-sectional view schematically showing the configuration of a positive electrode material 1000 of Embodiment 1. The positive electrode material 1000 includes a positive electrode active material 110, a first solid electrolyte material 111 coating at least partially the surface of the positive electrode active material 110, and a second electrolyte material 100. The positive electrode active material 110 includes an oxide consisting of Li, Ni, Mn, and O. The first solid electrolyte material 111 includes Li, Ti, M1, and F. M1 is at least one selected from the group consisting of Ca, Mg, Al, Y, and Zr.

With the above configuration, the positive electrode material 1000 has a high oxidation resistance. Consequently, the positive electrode material 1000 can suppress an increase in the internal resistance of a battery during charge. Furthermore, the first solid electrolyte material 111 has a high ionic conductivity. Consequently, in the positive electrode material 1000, a low interfacial resistance between the first solid electrolyte material 111 and the positive electrode active material 110 can be achieved. Therefore, the positive electrode material 1000 can enhance the charge and discharge capacity of a battery.

To further enhance the ionic conductivity of the first solid electrolyte material 111, the first solid electrolyte material 111 may contain an element other than F as an anion. Examples of the element, which may be contained as the anion, include Cl, Br, I, O, S, and Se. Furthermore, the first solid electrolyte material 111 may be free of sulfur.

The positive electrode active material 110 may include a material represented by the following composition formula (1).

LiNiₓMn₂₋ₓO₄ Formula (1)

The composition formula (1) satisfies 0<x<2.

The composition formula (1) may satisfy 0<x<1.

The composition formula (1) may satisfy x=0.5. That is, the positive electrode active material 110 may include LiNi_{0.5}Mn_{1.5}O₄.

An oxide represented by these chemical formulae is a material obtained by substituting a portion of Mn in LiMn₂O₄ having a spinel structure with Ni, and is suitable for enhancing the operating voltage of a battery. The oxide consisting of Li, Ni, Mn, and O can have a spinel structure as well. The “oxide consisting of Li, Ni, Mn, and O” means that elements except Li, Ni, Mn, and O are not intentionally added except for inevitable impurities.

Furthermore, owing to being free of Co, the material represented by the composition formula (1) is inexpensive. With the above configuration, it is possible to achieve the positive electrode material 1000 that is low-cost and can enhance the charge and discharge efficiency of a battery.

The positive electrode active material 110 may consist of LINi_{0.5}Mn_{1.5}O₄.

With the above configuration, the charge and discharge capacity of a battery is enhanced.

The first solid electrolyte material 111 may consist substantially of Li, Ti, M1, and F. The phrase “the first solid electrolyte material 111 consists substantially of Li, Ti, M1, and F” means that the molar ratio of the sum of the amounts of substance of Li, Ti, M1, and F to the total of the amounts of substance of all the elements constituting the first solid electrolyte material (i.e., the mole fraction) is 90% or more. In an example, the molar ratio may be 95% or more.

The first solid electrolyte material 111 may consist of Li, Ti, M1, and F.

The first solid electrolyte material 111 may include a material represented by the following composition formula (2A).

Li_{α2}Ti_{β2}M1_{γ2}F_{δ2} Formula (2A)

In the composition formula (2A), α2, β2, γ2, and δ2 are each a value greater than 0.

In the composition formula (2A), δ2 may be a value greater than α2, and δ2 may be a value greater than each of α2, β2, and γ2.

The composition formula (2A) may satisfy 1.7≤α2≤3.7, 0<β2<1.5, 0<γ2<1.5, and 5≤δ2×7.

The composition formula (2A) may satisfy 2.5≤α2≤3, 0.1≤β2≤0.6, 0.4≤γ2≤0.9, and δ2=6.

The first solid electrolyte material 111 may include the material represented by the composition formula (2A) as the main component. Here, the “main component” refers to a component having the highest content on a mass ratio basis.

The molar ratio of F to the sum of Li, Ti, M1, and F in the first solid electrolyte material 111 may be 0.4 or more and 0.8 or less, or may be 0.5 or more and 0.7 or less. The molar ratio of F to the sum of Li, Ti, M1, and F is calculated from (the amount of substance of F)/(the sum of the amounts of substance of Li, Ti, M1, and F).

The first solid electrolyte material 111 may include a material represented by the following composition formula (2B).

Li_{6-(4-a)b}(Ti₁₋ₐM1ₐ)_{b}F₆ Formula (2B)

The composition formula (2B) satisfies 0<a<1 and 0<b≤1.5.

To enhance the ionic conductivity of the first solid electrolyte material 111, the composition formula (2B) may satisfy 0.1≤a≤0.9.

To enhance the ionic conductivity of the first solid electrolyte material 111, the composition formula (2B) may satisfy 0.8≤b≤1.2.

In the case where the first solid electrolyte material 111 has a specific composition represented by the composition formula (2B), the first solid electrolyte material 111 exhibits, for example, the following ionic conductivity. For example, in the case where M1 is Zr, the first solid electrolyte material 111 exhibits an ionic conductivity of approximately 2.1 μS/cm. In the case where M1 is Mg, the first solid electrolyte material 111 exhibits an ionic conductivity of approximately 2.3 μS/cm. In the case where M1 is Ca, the first solid electrolyte material 111 exhibits an ionic conductivity of approximately 0.02 μS/cm. In the case where M1 is Al, the first solid electrolyte material 111 exhibits an ionic conductivity of approximately 5.4 μS/cm. On the other hand, the oxidation resistance of the first solid electrolyte material 111 is derived mainly from F. In view of these facts, even replacing, with respect to M1, a specific element by a different element still enhances the charge and discharge capacity of a battery.

M1 may be Al.

The first solid electrolyte material 111 may include the material represented by the composition formula (2B) as the main component. Here, the “main component” refers to a component having the highest content on a mass ratio basis.

With the above configuration, the first solid electrolyte material 111 exhibits a higher ionic conductivity. Consequently, in the positive electrode material 1000, a low interfacial resistance between the first solid electrolyte material 111 and the positive electrode active material 110 can be achieved.

The second electrolyte material 100 may include: Li; at least one selected from the group consisting of metalloid elements and metal elements except Li; and at least one selected from the group consisting of Cl and Br.

The “metalloid elements” refer to B, Si, Ge, As, Sb, and Te.

The “metal elements” refer to all the elements included in Groups 1 to 12 of the periodic table except hydrogen and all the elements included in Groups 13 to 16 except B, Si, Ge, As, Sb, Te, C, N, P, O, S, and Se. That is, the “metal elements” are a group of elements that can become a cation when forming an inorganic compound with a halogen compound.

The second electrolyte material 100 may include a material represented by the following composition formula (3).

Li_{α3}M2_{β3}X_{γ3}O_{δ3} Formula (3)

In the composition formula (3), α3, β3, and γ3 are each a value greater than 0, and δ3 is a value equal to or greater than 0, M2 is at least one selected from the group consisting of metalloid elements and metal elements except Li, and X is at least one selected from the group consisting of Cl and Br.

With the above configuration, the ionic conductivity of the second electrolyte material 100 can be further enhanced. Consequently, resistance derived from migration of Li ions in the positive electrode material 1000 can be further reduced.

In the composition formula (3), M2 may include at least one selected from the group consisting of Y and Ta. That is, the second electrolyte material 100 may include Y as a metal element.

With the above configuration, the ionic conductivity of the second electrolyte material 100 can be further enhanced. Consequently, resistance derived from migration of Li ions in the positive electrode material 1000 can be further reduced.

The composition formula (3) may satisfy 1≤α3≤4, 0<β3≤2, 3≤γ3<7, and 0≤δ3≤2.

With the above configuration, the ionic conductivity of the second electrolyte material 100 can be further enhanced. Consequently, resistance derived from migration of Li ions in the positive electrode material 1000 can be further reduced.

The composition formula (3) may satisfy 2.5≤α3≤3, 1≤β3≤1.1, γ3=6, and δ3=0.

The second electrolyte material 100 including Y may be, for example, a compound represented by a composition formula LiₐMe_{b}Y_{c}X₆. Here, a+m′b+3c=6 and c>0 are satisfied. Me is at least one element selected from the group consisting of metalloid elements and metal elements except Li and Y. Furthermore, m′ represents the valence of Me.

Me may be at least one element selected from the group consisting of Mg, Ca, Sr, Ba, Zn, Sc, Al, Ga, Bi, Zr, Hf, Ti, Sn, Ta, and Nb.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A1).

Li_{6-3d}Y_{d}X₆ Formula (A1)

In the composition formula (A1), X is a halogen element and includes Cl. Furthermore, the composition formula (A1) satisfies 0<d<2.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A2).

Li₃YX₆ Formula (A2)

In the composition formula (A2), X is a halogen element and includes Cl.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A3).

Li_{3-3δ}Y_{1+δ}Cl₆ Formula (A3)

The composition formula (A3) satisfies 0<δ≤0.15.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A4).

Li_{3-3δ+a4}Y_{1+δ-4}Meₐ₄Cl₆₋ₓ₄Brₓ₄ Formula (A4)

In the composition formula (A4), Me is at least one element selected from the group consisting of Mg, Ca, Sr, Ba, and Zn. Furthermore, the composition formula (A4) satisfies −1<δ<2, 0<a4<3, 0<(3−3δ+a4), 0<(1+δ−a4), and 0≤x4<6.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A5).

Li_{3-3δ}Y_{1+δ-a5}Meₐ₅Cl₆₋ₓ₅Brₓ₅ Formula (A5)

In the composition formula (A5), Me is at least one element selected from the group consisting of Al, Sc, Ga, and Bi. Furthermore, the composition formula (A5) satisfies −1<δ<1, 0<a5<2, 0<(1+δ−a5), and 0≤x5<6.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A6).

Li_{3-3δ-a6}Y_{1+δ-a6}Meₐ₆Cl₆₋ₓ₆Brₓ₆ Formula (A6)

In the composition formula (A6), Me is at least one element selected from the group consisting of Zr, Hf, and Ti. Furthermore, the composition formula (A6) satisfies −1<δ<1, 0<a6<1.5, 0<(3−3δ−a6), 0<(1+δ−a6), and 0≤x6<6.

With the above configuration, the ionic conductivity of the second electrolyte material 100 can be further enhanced. Consequently, resistance derived from migration of Li ions in the positive electrode material 1000 can be further reduced.

The second electrolyte material 100 may be a material represented by the following composition formula (A7).

Li_{3-3δ-2a7}Y_{1+δ-a7}Meₐ₇Cl₆₋ₓ₇Brₓ₇ Formula (A7)

In the composition formula (A7), Me is at least one element selected from the group consisting of Ta and Nb. Furthermore, the composition formula (A7) satisfies −1<δ<1, 0<a7<1.2, 0<(3−3δ−2a7), 0<(1+δ−a7), and 0≤x7<6.

With the above configuration, the ionic conductivity of the second electrolyte material 100 can be further enhanced. Consequently, resistance derived from migration of Li ions in the positive electrode material 1000 can be further reduced.

The second electrolyte material 100 can be, for example, Li₃YX₆, Li₂MgX₄, Li₂FeX₄, Li(Al,Ga,In)X₄, or L₃(Al,Ga,In)X₆. Here, X includes Cl. Note that, in the present disclosure, when an element in a formula is expressed by, for example, “(Al,Ga,In)”, this expression indicates at least one element selected from the group of elements in parentheses. That is, “(Al,Ga,In)” is synonymous with “at least one selected from the group consisting of Al, Ga, and In”. The same applies to other elements.

As the second electrolyte material 100, a sulfide solid electrolyte may be included. The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or Li₆PS₅Cl. Furthermore, LiX, Li₂O, MO_{q}, LiₚMO_{q}, or the like may be added to these. Here, X is at least one element selected from the group consisting of F, Cl, Br, and I. M is at least one element selected from the group consisting of P, Si, Ge, B, Al, Ga, In, Fe, and Zn. The symbols p and q are each independently a natural number.

The sulfide solid electrolyte may include lithium sulfide and phosphorus sulfide.

The sulfide solid electrolyte may be Li₆PS₅Cl.

The second electrolyte material 100 may be a solid electrolyte material.

The second electrolyte material 100 may include an electrolyte solution.

The electrolyte solution contains, as a solvent, water or a nonaqueous solvent, and contains a lithium salt dissolved in the solvent.

Examples of the solvent include water, a cyclic carbonate solvent, a linear carbonate solvent, a cyclic ether solvent, a linear ether solvent, a cyclic ester solvent, a linear ester solvent, and a fluorinated solvent.

Examples of the cyclic carbonate solvent include ethylene carbonate, propylene carbonate, and butylene carbonate.

Examples of the linear carbonate solvent include dimethyl carbonate, ethyl methyl carbonate, and diethyl carbonate.

Examples of the cyclic ether solvent include tetrahydrofuran, 1,4-dioxane, and 1,3-dioxolane.

Examples of the linear ether solvent include 1,2-dimethoxyethane and 1,2-diethoxyethane.

Examples of the cyclic ester solvent include γ-butyrolactone.

Examples of the linear ester solvent include methyl acetate.

Examples of the fluorinated solvent include fluoroethylene carbonate, methyl fluoropropionate, fluorobenzene, fluoroethyl methyl carbonate, and fluorodimethylene carbonate.

As the solvent, one solvent selected from these can be used alone, or alternatively, a combination of two or more solvents selected from these can be used.

The electrolyte solution may contain at least one fluorinated solvent selected from the group consisting of fluoroethylene carbonate, methyl fluoropropionate, fluorobenzene, fluoroethyl methyl carbonate, and fluorodimethylene carbonate.

The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄Fe), LiC(SO₂CF₃)₃, or the like. As the lithium salt, one lithium salt selected from these can be used alone, or alternatively, a mixture of two or more lithium salts selected from these can be used. The lithium salt has a concentration, for example, in a range of 0.1 mol/L to 15 mol/L.

The positive electrode material 1000 may further include a positive electrode active material other than the oxide consisting of Li, Ni, Mn, and O.

The positive electrode active material includes a material having properties of occluding and releasing metal ions (e.g., lithium ions). The positive electrode active material other than the positive electrode active material 110 can be, for example, a lithium-containing transition metal oxide, a transition metal fluoride, a polyanion material, a fluorinated polyanion material, a transition metal sulfide, a transition metal oxysulfide, or a transition metal oxynitride. Examples of the lithium-containing transition metal oxide include Li(Ni,Co,Al)O₂, Li(Ni,Co,Mn)O₂, and LiCoO₂. In particular, in the case where the lithium-containing transition metal oxide is used, it is possible to reduce the manufacturing costs of the positive electrode material 1000, and to enhance the average discharge voltage.

The first solid electrolyte material 111 may be provided between the positive electrode active material 110 and the second electrolyte material 100.

With the above configuration, since the first solid electrolyte material 111 having a high oxidation resistance is interposed between the positive electrode active material 110 and the second electrolyte material 100, oxidative decomposition of the second electrolyte material 100 can be suppressed. Therefore, it is possible to suppress a decrease in the capacity of a battery including the positive electrode material 1000 during charge.

The positive electrode material 1000 may further include a third electrolyte material that is a material having composition different from the composition of the second electrolyte material 100.

The first solid electrolyte material 111 coating at least partially the surface of the positive electrode active material 110 may have a thickness of 1 nm or more and 500 nm or less.

In the case where the first solid electrolyte material 111 has a thickness of 1 nm or more, a direct contact between the positive electrode active material 110 and the second electrolyte material 100 can be suppressed, thereby suppressing oxidative decomposition of the second electrolyte material 100. Consequently, it is possible to enhance the charge and discharge efficiency of the battery including the positive electrode material 1000. In the case where the first solid electrolyte material 111 has a thickness of 500 nm or less, the first solid electrolyte material 111 is not excessively large in thickness. Consequently, it is possible to sufficiently reduce the internal resistance of the battery including the positive electrode material 1000, thereby enhancing the energy density of the battery.

In addition, the method of measuring the thickness of the first solid electrolyte material 111 is not particularly limited. For example, a transmission electron microscope can be used to directly observe the first solid electrolyte material 111 and thus to determine the thickness.

The mass proportion of the first solid electrolyte material 111 to the positive electrode active material 110 may be 0.01% or more and 30% or less.

In the case where the mass proportion of the first solid electrolyte material 111 to the positive electrode active material 110 is 0.01% or more, a direct contact between the positive electrode active material 110 and the second electrolyte material 100 can be suppressed, thereby suppressing oxidative decomposition of the second electrolyte material 100. Consequently, it is possible to enhance the charge and discharge efficiency of the battery including the positive electrode material 1000. In the case where the mass proportion of the first solid electrolyte material 111 to the positive electrode active material 110 is 30% or less, the thickness of the first solid electrolyte material 111 is not excessively large. Consequently, it is possible to sufficiently reduce the internal resistance of the battery including the positive electrode material 1000, thereby enhancing the energy density of the battery.

The first solid electrolyte material 111 may coat uniformly the surface of the positive electrode active material 110. In this case, a direct contact between the positive electrode active material 110 and the second electrolyte material 100 can be suppressed, thereby suppressing a side reaction of the second electrolyte material 100. Therefore, it is possible to further enhance the charge and discharge characteristics of the battery including the positive electrode material 1000 and to suppress a decrease in the capacity of the battery including the positive electrode material 1000.

The first solid electrolyte material 111 may coat partially the surface of the positive electrode active material 110. In this case, the plurality of positive electrode active materials 110 are in direct contact with each other via their portions uncoated with the first solid electrolyte material 111. Consequently, the electronic conductivity between the plurality of positive electrode active materials 110 is enhanced. This enables the battery including the positive electrode material 1000 to operate at a high power.

The first solid electrolyte material 111 may coat 30% or more, 60% or more, or 90% or more of the surface of the positive electrode active material 110. The first solid electrolyte material 111 may coat substantially the entire surface of the positive electrode active material 110.

The first solid electrolyte material 111 may be in direct contact with the surface of the positive electrode active material 110.

The surface of the positive electrode active material 110 may be at least partially coated with a coating material that is different from the first solid electrolyte material 111.

Examples of the coating material include a sulfide solid electrolyte, an oxide solid electrolyte, and a fluoride solid electrolyte. The sulfide solid electrolyte used as the coating material may be the same material as those exemplified for the second electrolyte material 100. The oxide solid electrolyte used as the coating material is, for example, a Li—Nb—O compound, such as LiNbO₃, a Li—B—O compound, such as LiBO₂ or Li₃BO₃, a Li—Al—O compound, such as LiAlO₂, a Li—Si—O compound, such as Li₄SiO₄, a Li—Ti—O compound, such as Li₂SO₄ or Li₄Ti₅O₁₂, a Li—Zr—O compound, such as Li₂ZrO₃, a Li—Mo—O compound, such as Li₂MoO₃, a Li-V-O compound, such as LiV₂O₅, a Li—W—O compound, such as Li₂WO₄, or a Li—P—O compound, such as Li₃PO₄. The fluoride solid electrolyte used as the coating material is, for example, a solid electrolyte including Li, Ti, M1, and F, where M1 is at least one element selected from the group consisting of Ca, Mg, Al, Y, and Zr.

With the above configuration, the oxidation resistance of the positive electrode material 1000 can be further enhanced. Consequently, a decrease in the capacity of the battery during charge can be suppressed.

The positive electrode active material 110 and the first solid electrolyte material 111 may be separated from each other by the coating material so as not to be in direct contact with each other.

With the above configuration, the oxidation resistance of the positive electrode material 1000 can be further enhanced. Consequently, a decrease in the capacity of the battery during charge can be suppressed.

The shape of the second electrolyte material 100 is not particularly limited. In the case where the second electrolyte material 100 is a powdery material, its shape may be, for example, an acicular, spherical, or ellipsoidal shape. The second electrolyte material 100 may be, for example, particulate.

For example, in the case where the second electrolyte material 100 is particulate (e.g., spherical), the second electrolyte material 100 may have a median diameter of 100 μm or less. In the case where the second electrolyte material 100 has a median diameter of 100 μm or less, the positive electrode active material 110 and the second electrolyte material 100 can form a favorable dispersion state in the positive electrode material 1000. This enhances the charge and discharge characteristics of the battery including the positive electrode material 1000.

The second electrolyte material 100 may have a median diameter of 10 μm or less. With the above configuration, the positive electrode active material 110 and the second electrolyte material 100 can form a favorable dispersion state in the positive electrode material 1000. In Embodiment 1, the second electrolyte material 100 may have a smaller median diameter than the positive electrode active material 110 has. With the above configuration, the second electrolyte material 100 and the positive electrode active material 110 can form a more favorable dispersion state in the positive electrode.

The positive electrode active material 110 may have a median diameter of 0.1 μm or more and 100 μm or less.

In the case where the positive electrode active material 110 may have a diameter of 0.1 μm or more, the positive electrode active material 110 and the second electrolyte material 100 can form a favorable dispersion state in the positive electrode material 1000. This enhances the charge and discharge characteristics of the battery including the positive electrode material 1000. In the case where the positive electrode active material 110 has a median diameter of 100 μm or less, the diffusion rate of lithium in the positive electrode active material 110 is enhanced. This enables the battery including the positive electrode material 1000 to operate at a high power.

The positive electrode active material 110 may have a larger median diameter than the second electrolyte material 100 has. In this case, the positive electrode active material 110 and the second electrolyte material 100 can form a favorable dispersion state.

In the present disclosure, the “median diameter” means the particle diameter at a cumulative volume equal to 50% in the volumetric particle size distribution. The volumetric particle size distribution is measured, for example, with a laser diffraction analyzer or an image analyzer.

In the positive electrode material 1000, the second electrolyte material 100 and the first solid electrolyte material 111 may be in contact with each other as shown in FIG. 1. At this time, the first solid electrolyte material 111 and the positive electrode active material 110 are in contact with each other.

The positive electrode material 1000 may include the plurality of second electrolyte materials 100 and the plurality of positive electrode active materials 110.

In the positive electrode material 1000, the content of the second electrolyte material 100 and the content of the positive electrode active material 110 may be the same, or may be different from each other.

### <Method of Manufacturing First Solid Electrolyte Material 111>

The first solid electrolyte material 111 of Embodiment 1 can be manufactured, for example, by the following method.

Raw material powders of a binary halide are prepared so as to obtain a blending ratio of a desired composition. For example, to produce Li_{2.7}Ti_{0.3}Al_{0.7}F₆, LiF, TiF₄, and AlF₃ are prepared in an approximate molar ratio of LiF:TiF₄:AlF₃=2.7:0.3:0.7. The blending ratio may be adjusted in advance so as to cancel out a composition change which can occur in the synthesis process.

The raw material powders are well mixed together, and then mixed, pulverized, and reacted together by mechanochemical milling. Subsequently, the raw material powders may be fired in a vacuum or in an inert atmosphere.

Alternatively, the raw material powders may be well mixed together, and then fired in a vacuum or in an inert atmosphere. The firing conditions is preferably, for example, firing within a range of 100° C. to 300° C. for 1 hour or more. Furthermore, to suppress a composition change in the firing process, the firing is performed preferably by sealing the raw material powders in a closed vessel, such as a quartz tube.

Thus, the first solid electrolyte material 111 having such composition as the composition described above is obtained.

<Method of Manufacturing Positive Electrode Active Material 110 Having Surface Coated with First Solid Electrolyte Material 111>

The positive electrode active material having a surface coated with the first solid electrolyte material 111 can be manufactured, for example, by the following method.

The positive electrode active material 110 and the first solid electrolyte material 111 are prepared in a predetermined mass ratio. For example, LiNi_{0.5}Mn_{1.5}O₄ as the positive electrode active material 110 and Li_{2.7}Ti_{0.3}Al_{0.7}F₆ as the first solid electrolyte material 111 are prepared. These two materials are put into the same reaction vessel. A shear force is imparted to the two materials with rotating blades, or a jet stream is used to collide the two materials with each other, for example. By such a method, the surface of the positive electrode active material LiNi_{0.5}Mn_{1.5}O₄ can be at least partially coated with Li_{2.7}Ti_{0.3}Al_{0.7}F₆ which is the first solid electrolyte material 111. For example, a device can be used, such as a dry particle composing machine NOBILTA (manufactured by Hosokawa Micron Corporation), a high-speed flow impact machine (manufactured by Nara Machinery Co., Ltd.), or a jet mill. Thus, it is possible to manufacture the positive electrode active material 110 in which the positive electrode active material LiNi_{0.5}Mn_{1.5}O₄ has a surface at least partially coated with Li_{2.7}Ti_{0.3}Al_{0.7}F₆ which is the first solid electrolyte material 111.

### <Method of Manufacturing Second Electrolyte Material 100>

The second electrolyte material 100 can be manufactured by the following method.

In an example, to synthesize the second electrolyte material 100 consisting of Li, Y, Cl, and Br, raw material powders LiCl, LiBr, YBr₃, and YCl₃ are mixed together. The raw material powders may be mixed together in a molar ratio adjusted in advance so as to cancel out a composition change which can occur in the synthesis process. Thus, the second electrolyte material 100 is obtained.

### <Method of Manufacturing Positive Electrode Material 1000>

The positive electrode active material 110 having a surface coated with the first solid electrolyte material 111 and the second electrolyte material 100 are mixed together. Thus, the positive electrode material 1000 of Embodiment 1 can be manufactured.

### Embodiment 2

Embodiment 2 will be described below. The description overlapping with that of Embodiment 1 will be omitted as appropriate.

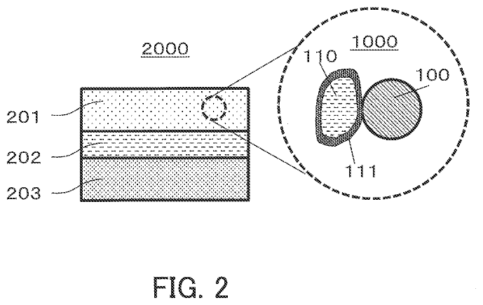

FIG. 2 is a cross-sectional view schematically showing the configuration of a battery 2000 of Embodiment 2.

The battery 2000 of Embodiment 2 includes a positive electrode 201, an electrolyte layer 202, and a negative electrode 203. The positive electrode 201 includes the positive electrode material 1000 of Embodiment 1. The electrolyte layer 202 is disposed between the positive electrode 201 and the negative electrode 203.

With the above configuration, an increase in the internal resistance of the battery 2000 during charge can be suppressed.

In the volume ratio “v1:100−v1” between the positive electrode material 1000 and the second electrolyte material 100 included in the positive electrode 201, 30≤v1≤98 may be satisfied. Here, v1 represents the volume ratio of the positive electrode material 1000 based on 100 of the total volume of the positive electrode material 1000 and the second electrolyte material 100 included in the positive electrode 201. In the case where 30≤v1 is satisfied, a sufficient energy density of the battery can be achieved. In the case where v1≤98 is satisfied, the battery 2000 can operate at a high power.

The positive electrode 201 may have a thickness of 10 μm or more and 500 μm or less. In the case where the positive electrode 201 has a thickness of 10 μm or more, a sufficient energy density of the battery can be achieved. In the case where the positive electrode 201 has a thickness of 500 μm or less, the battery 2000 can operate at a high power.

The electrolyte layer 202 includes an electrolyte material. The electrolyte material may be, for example, a solid electrolyte material. That is, the electrolyte layer 202 may be a solid electrolyte layer.

The solid electrolyte material included in the electrolyte layer 202 may be a material that is the same as the first solid electrolyte material 111 of Embodiment 1 or the same as the second electrolyte material 100 of Embodiment 1. That is, the electrolyte layer 202 may include a material having the same composition as the composition of the first solid electrolyte material 111 of Embodiment 1 or having the same composition as the composition of the second electrolyte material 100 of Embodiment 1.

With the above configuration, the output density and the charge and discharge characteristics of the battery 2000 can be further enhanced.

The solid electrolyte material included in the electrolyte layer 202 may be the same material as the first solid electrolyte material 111 of Embodiment 1. That is, the electrolyte layer 202 may include a material having the same composition as the composition of the first solid electrolyte material 111 of Embodiment 1.

With the above configuration, an increase in the internal resistance of the battery 2000 caused by oxidation of the electrolyte layer 202 can be suppressed, thereby further enhancing the output density and the charge and discharge characteristics of the battery 2000.

The solid electrolyte material included in the electrolyte layer 202 may be a halide solid electrolyte, a sulfide solid electrolyte, an oxide solid electrolyte, a polymer solid electrolyte, or a complex hydride solid electrolyte.

The oxide solid electrolyte as the solid electrolyte material included in the electrolyte layer 202 can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; or glass or glass ceramics including a Li—B—O compound, such as LiBO₂ or Li₃BO₃, as a base, and to which Li₂SO₄, Li₂CO₃, or the like is added.

The polymer solid electrolyte can be, for example, a compound of a polymer compound and a lithium salt. The polymer compound may have an ethylene oxide structure. The polymer compound having an ethylene oxide structure can contain a large amount of a lithium salt. Consequently, the ionic conductivity can be further enhanced. The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LC(SO₂CF₃)₃, or the like. One lithium salt selected from the exemplified lithium salts can be used alone. Alternatively, a mixture of two or more lithium salts selected from the exemplified lithium salts can be used.

The complex hydride solid electrolyte can be, for example, LiBH₄—LiI or LiBH₄—P₂S₅.

The solid electrolyte material included in the electrolyte layer 202 may be a halide solid electrolyte. That is, the electrolyte layer 202 may include a halide solid electrolyte.

The halide solid electrolyte, which may be included in the electrolyte layer 202, may include Li; at least one selected from the group consisting of metalloid elements and metal elements except Li; and at least one selected from the group consisting of F, Cl, Br, and I.

The halide solid electrolyte, which may be included in the electrolyte layer 202, may include Li; at least one selected from the group consisting of metalloid elements and metal elements except Li; and at least one selected from the group consisting of Cl and Br.

The halide solid electrolyte, which may be included in the electrolyte layer 202, may be the halide solid electrolytes exemplified for the second electrolyte material. For example, a halide solid electrolyte represented by the above composition formula (3) may be used. In the composition formula (3), α3, β3, and γ3 are each a value greater than 0, and δ3 is a value equal to or greater than 0, M2 is at least one selected from the group consisting of metalloid elements and metal elements except Li, and X is at least one selected from the group consisting of Cl and Br.

The composition formula (3) may satisfy 1≤α3≤4, may satisfy 0<β3≤2, may satisfy 3≤γ3<7, and may satisfy 0≤δ3≤2.

The electrolyte layer 202 may include the solid electrolyte material as the main component. That is, the electrolyte layer 202 may include the solid electrolyte material, for example, in a mass proportion of 50% or more (i.e., 50 mass % or more) to the entire electrolyte layer 202.

With the above configuration, the charge and discharge characteristics of the battery can be further enhanced.

The electrolyte layer 202 may include the solid electrolyte material, for example, in a mass proportion of 70% or more (i.e., 70 mass % or more) to the entire electrolyte layer 202.

With the above configuration, the charge and discharge characteristics of the battery 2000 can be further enhanced.

The electrolyte layer 202 may include the solid electrolyte material as the main component and further include inevitable impurities, a starting material used for synthesis of the solid electrolyte material, a by-product, a decomposition product, etc.

The electrolyte layer 202 may include the solid electrolyte material, for example, in a mass proportion of 100% (i.e., 100 mass %) to the entire electrolyte layer 202, except for inevitably incorporated impurities.

With the above configuration, the charge and discharge characteristics of the battery 2000 can be further enhanced.

The electrolyte layer 202 may consist of the solid electrolyte material.

The electrolyte layer 202 may include two or more of the materials listed as the solid electrolyte material. For example, the electrolyte layer 202 may include a halide solid electrolyte and a sulfide solid electrolyte.

The electrolyte layer 202 may have a thickness of 1 μm or more and 300 μm or less. In the case where the electrolyte layer 202 has a thickness of 1 μm or more, a short circuit between the positive electrode 201 and the negative electrode 203 tends not to occur. In the case where the electrolyte layer 202 has a thickness of 300 μm or less, the battery 2000 can operate at a high power.

The negative electrode 203 includes a material having properties of occluding and releasing metal ions (e.g., lithium ions). The negative electrode 203 includes, for example, a negative electrode active material.

The negative electrode active material can be a metal material, a carbon material, an oxide, a nitride, a tin compound, a silicon compound, or the like. The metal material may be a simple substance of metal. Alternatively, the metal material may be an alloy. Examples of the metal material include lithium metal and a lithium alloy. Examples of the carbon material include natural graphite, coke, semi-graphitized carbon, a carbon fiber, spherical carbon, artificial graphite, and amorphous carbon. From the viewpoint of capacity density, silicon, tin, a silicon compound, or a tin compound can be used.

The negative electrode 203 may include a solid electrolyte material. As the solid electrolyte material, the solid electrolyte materials exemplified as the materials of the electrolyte layer 202 may be used. With the above configuration, the lithium-ion conductivity inside the negative electrode 203 can be enhanced, and consequently the battery 2000 can operate at a high power.

The negative electrode active material may have a median diameter of 0.1 μm or more and 100 μm or less. In the case where the negative electrode active material has a median diameter of 0.1 μm or more, the negative electrode active material and the solid electrolyte material can form a favorable dispersion state in the negative electrode. This enhances the charge and discharge characteristics of the battery 2000. In the case where the negative electrode active material has a median diameter of 100 μm or less, diffusion of lithium in the negative electrode active material is fast. This enables the battery 2000 to operate at a high power.

The negative electrode active material may have a larger median diameter than the solid electrolyte material included in the negative electrode 203 has. In this case, a favorable dispersion state of the negative electrode active material and the solid electrolyte material can be formed.

In the volume ratio “v2:100−v2” between the negative electrode active material and the solid electrolyte material included in the negative electrode 203, 30≤v2≤95 may be satisfied. Here, v2 represents the volume ratio of the negative electrode active material based on 100 of the total volume of the negative electrode active material and the solid electrolyte material included in the negative electrode 203. In the case where 30≤v2 is satisfied, a sufficient energy density of the battery can be achieved. In the case where v2≤95 is satisfied, the battery 2000 can operate at a high power.

The negative electrode 203 may have a thickness of 10 μm or more and 500 μm or less. In the case where the negative electrode 203 has a thickness of 10 μm or more, a sufficient energy density of the battery 2000 can be achieved. In the case where the negative electrode 203 has a thickness of 500 μm or less, the battery 2000 can operate at a high power.

At least one selected from the group consisting of the positive electrode 201, the electrolyte layer 202 and the negative electrode 203 may contain a binder for the purpose of enhancing the adhesion between the particles. The binder is used to enhance the binding properties of the materials of the electrodes. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. Furthermore, as the binder can also be used a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Moreover, a mixture of two or more selected from these may also be used.

At least one of the positive electrode 201 and the negative electrode 203 may contain a conductive additive for the purpose of enhancing the electronic conductivity. The conductive additive can be, for example: a graphite, such as natural graphite or artificial graphite; a carbon black, such as acetylene black or Ketjenblack; a conductive fiber, such as a carbon fiber or a metal fiber; carbon fluoride; a metal powder, such as an aluminum powder; a conductive whisker, such as a zinc oxide whisker or a potassium titanate whisker; a conductive metal oxide, such as titanium oxide; or a conductive polymer compound, such as polyaniline compound, polypyrrole compound, or polythiophene compound. Using a conductive carbon additive as the conductive additive can seek cost reduction.

The shape of the battery 2000 of Embodiment 2 is, for example, a coin type, a cylindrical type, a prismatic type, a sheet type, a button type, a flat type, or a stack type.

The battery 2000 may be manufactured, for example, by preparing each of the positive electrode material 1000, a material for forming an electrolyte layer, and a material for forming a negative electrode, and producing by a known method a stack in which a positive electrode, the electrolyte layer, and the negative electrode are disposed in this order.

### Embodiment 3

Embodiment 3 will be described below. The description overlapping with that of Embodiment 1 will be omitted as appropriate.

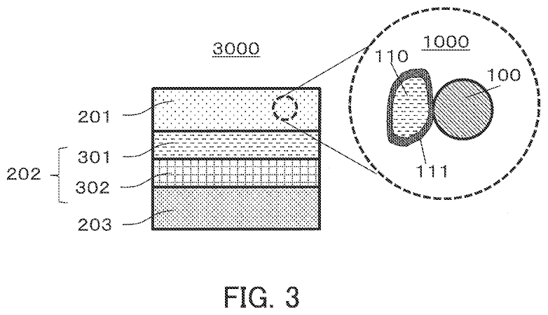

FIG. 3 is a cross-sectional view schematically showing the configuration of a battery 3000 of Embodiment 3.

The battery 3000 of Embodiment 3 includes the positive electrode 201, the electrolyte layer 202, and the negative electrode 203. The positive electrode 201 includes the positive electrode material 1000 of Embodiment 1. The electrolyte layer 202 is disposed between the positive electrode 201 and the negative electrode 203. The electrolyte layer 202 includes a first electrolyte layer 301 and a second electrolyte layer 302. The first electrolyte layer 301 is in contact with the positive electrode 201, and the second electrolyte layer 302 is in contact with the negative electrode 203.

With the above configuration, an increase in the internal resistance of the battery 3000 during charge can be suppressed.

The first electrolyte layer 301 may include a material having the same composition as the composition of the first solid electrolyte material 111.

In the case where the first electrolyte layer 301 in contact with the positive electrode 201 includes a material having the same composition as the composition of the first solid electrolyte material 111 having an excellent oxidation resistance, oxidative decomposition of the first electrolyte layer 301 can be suppressed, thereby suppressing an increase in the internal resistance of the battery 3000 during charge.

The first electrolyte layer 301 may include a material having the same composition as the composition of the second electrolyte material 100.

In addition, the second electrolyte layer 302 may include a material having composition different from the composition of the first solid electrolyte material 111.

The second electrolyte layer 302 may include a material having the same composition as the composition of the second electrolyte material 100.

From the viewpoint of the reduction resistance of solid electrolyte materials, the reduction potential of the solid electrolyte material included in the first electrolyte layer 301 may be lower than the reduction potential of the solid electrolyte material included in the second electrolyte layer 302. With the above configuration, the solid electrolyte material included in the first electrolyte layer 301 can be used without being reduced. Consequently, the charge and discharge efficiency of the battery 3000 can be enhanced.

For example, the second electrolyte layer 302 may include a sulfide solid electrolyte. Here, the reduction potential of the sulfide solid electrolyte included in the second electrolyte layer 302 is lower than the reduction potential of the solid electrolyte material included in the first electrolyte layer 301. With the above configuration, the solid electrolyte material included in the first electrolyte layer 301 can be used without being reduced. Consequently, the charge and discharge efficiency of the battery 3000 can be enhanced.

The first electrolyte layer 301 and the second electrolyte layer 302 each may have a thickness of 1 μm or more and 300 μm or less. In the case where the first electrolyte layer 301 and the second electrolyte layer 302 each have a thickness of 1 μm or more, a short circuit between the positive electrode 201 and the negative electrode 203 tends not to occur. In the case where the first electrolyte layer 301 and the second electrolyte layer 302 each have a thickness of 300 μm or less, the battery 3000 can operate at a high power.

### EXAMPLES

The present disclosure will be described below in more detail with reference to examples.

### Example 1

### [Production of First Solid Electrolyte Material]

In an argon atmosphere, raw material powders LiF, TiF₄, and AlF₃ were weighed in a molar ratio of LiF:TiF₄:AlF₃=2.7:0.3:0.7. Subsequently, these raw material powders were milled with a planetary ball mill (Type P-7 manufactured by Fritsch GmbH) at 500 rpm for 12 hours thus to obtain powdered Li_{2.7}Ti_{0.3}Al_{0.7}F₆ as a first solid electrolyte material of Example 1.

[Production of Positive Electrode Active Material Having Surface Coated with First Solid Electrolyte Material]

In an argon atmosphere, the positive electrode active material LiNi_{0.5}Mn_{1.5}O₄ and the first solid electrolyte material of Example 1 were weighed in a mass ratio of LiNi_{0.5}Mn_{1.5}O₄:the first solid electrolyte material=100:3. These materials were put into a dry particle composing machine NOBILTA (manufactured by Hosokawa Micron Corporation) and subjected to a composing process at 6000 rpm for 30 minutes. Thus, a positive electrode active material having a surface coated with the first solid electrolyte material of Example 1 was obtained.

### [Production of Second Electrolyte Material]

In a dry atmosphere with a dew point of −30° C. or lower (hereinafter referred to as a “dry atmosphere”), raw material powders Li₂O₂ and TaCl₅ were prepared in a molar ratio of Li₂O₂:TaCl₅=1.2:2. These raw material powders were pulverized and mixed together in a mortar to obtain a mixed powder. The obtained mixed powder was milled with a planetary ball mill at 600 rpm for 24 hours. Next, the mixed powder was fired at 200° C. for 6 hours. Thus, a powdered second electrolyte material of Example 1 was obtained.

### [Production of Positive Electrode Material]

The positive electrode active material having a surface coated with the first solid electrolyte material of Example 1, the second electrolyte material of Example 1, and vapor-grown carbon fibers (VGCF (manufactured by SHOWA DENKO K.K.)) were weighed in a mass ratio of 73.4:25.6:1.0, and were mixed together in a mortar. Thus, a positive electrode material of Example 1 was produced.

### Example 2

[Production of Positive Electrode Active Material Having Surface Coated with First Solid Electrolyte Material]

A first solid electrolyte material was produced in the same manner as in Example 1. Furthermore, a positive electrode active material having a surface coated with the first solid electrolyte material was produced in the same manner as in Example 1.

### [Production of Second Electrolyte Material]

In an argon glove box with a dew point of −60° C. or lower, raw material powders LiCl and YCl₃ were prepared in a molar ratio of LiCl:YCl₃=2.7:1.1. Subsequently, these raw material powders were milled with a planetary ball mill (Type P-5 manufactured by Fritsch GmbH) at 600 rpm for 25 hours thus to obtain powdered Li_{2.7}Y_{1.1}Cl₆ as the second electrolyte material.

### [Production of Positive Electrode Material]

The positive electrode active material having a surface coated with the first solid electrolyte material, the second electrolyte material Li_{2.7}Y_{1.1}Cl₆, and the conductive additive VGCF were weighed in a mass ratio of the coated positive electrode active material:the second electrolyte material:VGCF=73.4:25.6:1.0, and were mixed together in a mortar. Thus, a positive electrode material of Example 2 was produced.

### Example 3

[Production of Positive Electrode Active Material Having Surface Coated with First Solid Electrolyte Material]

A first solid electrolyte material was produced in the same manner as in Example 1. Furthermore, a positive electrode active material having a surface coated with the first solid electrolyte material was produced in the same manner as in Example 1.

### [Production of Second Electrolyte Material]

In an argon atmosphere, raw material powders LiBr, YBr₃, LiCl, and YCl₃ were weighed in a molar ratio of LiBr:YBr₃:LiCl:YCl₃=1:1:5:1. Subsequently, these raw material powders were milled with a planetary ball mill (Type P-7 manufactured by Fritsch GmbH) at 600 rpm for 25 hours thus to obtain powdered Li₃YBr₂Cl₄ as the second electrolyte material.

### [Production of Positive Electrode Material]

The positive electrode active material having a surface coated with the first solid electrolyte material, the second electrolyte material Li₃YBr₂Cl₄, and the conductive additive VGCF were weighed in a mass ratio of the coated positive electrode active material:the second electrolyte material:VGCF=73.4:25.6:1.0, and were mixed together in a mortar. Thus, a positive electrode material of Example 3 was produced.

### Example 4

[Production of Positive Electrode Active Material Having Surface Coated with First Solid Electrolyte Material]

A first solid electrolyte material was produced in the same manner as in Example 1. Furthermore, a positive electrode active material having a surface coated with the first solid electrolyte material was produced in the same manner as in Example 1.

### [Production of Positive Electrode Material]

The positive electrode active material having a surface coated with the first solid electrolyte material, the second electrolyte material Li₆PS₅Cl, and the conductive additive VGCF were weighed in a mass ratio of the coated positive electrode active material:Li₆PS₅Cl:VGCF=73.4:25.6:1.0, and were mixed together in a mortar. Thus, a positive electrode material of Example 4 was produced.

### Reference Example 1

### [Production of Positive Electrode Material]

The positive electrode active material LiNi_{0.5}Mn_{1.5}O₄, the second electrolyte material of Example 1, and the conductive additive VGCF were weighed in a mass ratio of LiNi_{0.5}Mn_{1.5}O₄:the second electrolyte material:VGCF=72.8:26.2:1.0, and were mixed together in a mortar. Thus, a positive electrode material of Reference Example 1 was produced.

### Reference Example 2

### [Production of Positive Electrode Material]

The positive electrode active material LiNi_{0.5}Mn_{1.5}O₄, the second electrolyte material Li_{2.7}Y_{1.1}Cl₆ of Example 2, and the conductive additive VGCF were weighed in a mass ratio of LiNi_{0.5}Mn_{1.5}O₄:the second electrolyte material:VGCF=72.8:26.2:1.0, and were mixed in a mortar. Thus, a positive electrode material of Reference Example 2 was produced.

### Reference Example 3

### [Production of Positive Electrode Material]

The positive electrode active material LiNi_{0.5}Mn_{1.5}O₄, the second electrolyte material Li₃YBr₂Cl₄ of Example 3, and the conductive additive VGCF were weighed in a mass ratio of LiNi_{0.5}Mn_{1.5}O₄:the second electrolyte material:VGCF=72.8:26.2:1.0, and were mixed together in a mortar. Thus, a positive electrode material of Reference Example 3 was produced.

### Reference Example 4

### [Production of Positive Electrode Material]

The positive electrode active material LiNi_{0.5}Mn_{1.5}O₄, Li_{2.7}Ti_{0.3}Al_{0.7}F₆, and the conductive additive VGCF were weighed in a mass ratio of LiNi_{0.5}Mn_{1.5}O₄:Li_{2.7}Ti_{0.3}Al_{0.7}F₆:VGCF=72.8:26.2:1.0, and were mixed together in a mortar. Thus, a positive electrode material of Reference Example 4 was produced.

### Reference Example 5

### [Production of Positive Electrode Material]

The positive electrode active material LiNi_{0.5}Mn_{1.5}O₄, Li₆PS₅Cl, and the conductive additive VGCF were weighed in a mass ratio of LiNi_{0.5}Mn_{1.5}O₄:Li₆PS₅Cl:VGCF=72.8:26.2:1.0, and were mixed together in a mortar. Thus, a positive electrode material of Reference Example 5 was produced.

### [Production of Battery]

Respective batteries including the positive electrode materials of Examples 1 to 4 and Reference Examples 1 to 5 described above were produced by the following steps.

### Example 1

First, 80 mg of Li₆PS₅Cl was put into an insulating outer cylinder and pressure-molded at a pressure of 2 MPa. Next, 20 mg of the second electrolyte material used for the positive electrode material of Example 1 was put and pressure-molded at a pressure of 2 MPa. Furthermore, 9.8 mg of the positive electrode material was put and pressure-molded at a pressure of 720 MPa. Thus, a stack composed of a positive electrode and a solid electrolyte layer was obtained.

Next, metal Li was stacked on one side of the solid electrolyte layer opposite to the other side in contact with the positive electrode. The metal Li used had a thickness of 200 μm. This was pressure-molded at a pressure of 2 MPa to produce a stack composed of the positive electrode, the solid electrolyte layer, and a negative electrode.

Next, stainless steel current collectors were placed on the top and the bottom of the stack, and current collector leads were attached to the current collectors.

Finally, an insulating ferrule was used to block the inside of the insulating outer cylinder from the outside air atmosphere and hermetically seal the insulating outer cylinder. Thus, the battery of Example 1 was produced.

### Examples 2 to 4 and Reference Examples 1 to 5

An amount of 80 mg of Li₆PS₅Cl was put into an insulating outer cylinder and pressure-molded at a pressure of 2 MPa. Next, 20 mg of the second electrolyte material used for each of the positive electrode materials of Examples 2 to 4 and Reference Examples 1 to 5 was put and pressure-molded at a pressure of 2 MPa. Furthermore, 9.8 mg of the positive electrode material was put for Examples 2 to 4, and 9.6 mg of the positive electrode material was put for Reference Examples 1 to 5. This was pressure-molded at a pressure of 720 MPa. Thus, a stack composed of a positive electrode and a solid electrolyte layer was obtained. In the same manner as in Example 1 except the above, the respective batteries of Examples 2 to 4 and Reference Examples 1 to 5 were produced.

Thus, the respective batteries of Examples 1 to 4 and Reference Examples 1 to 5 described above were produced.

### [Charge and Discharge Test]

A charge and discharge test was performed on the respective batteries of Examples 1 to 4 and Reference Examples 1 to 5 described above under the following conditions.

The battery was placed in a thermostatic chamber set at 25° C.

Constant-current charge was performed at a current value of 42 μA equivalent to 0.05 C rate (20-hour rate) relative to the theoretical capacity of the battery. The end-of-charge voltage was set to 5.0 V (vs. Li/Li⁺). Next, constant-current discharge was performed. The end-of-discharge voltage was set to 3.5 V (vs. Li/Li⁺).

The results of the charge and discharge test on the batteries of Examples 1 to 4 and Reference Examples 1 to 5 are shown in Table 1.

TABLE 1

| | | | | | | | Capacity |
|---|---|---|---|---|---|---|---|
| | Positive | | | Initial | Initial | Average | ratio |
| | electrode | First solid | Second | charge | discharge | discharge | coating/ |
| | active | electrolyte | electrolyte | capacity | capacity | voltage | non- |
| | material | material | material | (mAh/g) | (mAh/g) | (V) | coating |
| Example 1 | LiNi_{0.5}Mn_{1.5}O₄ | Li_{2.7}Ti_{0.3}Al_{0.7}F₆ | Li—Ta—Cl—O | 114 | 103 | 4.47 | 4.29 |
| Example 2 | LiNi_{0.5}Mn_{1.5}O₄ | Li_{2.7}Ti_{0.3}Al_{0.7}F₆ | Li—Y—Cl | 89 | 77 | 4.42 | 5.13 |
| Example 3 | LiNi_{0.5}Mn_{1.5}O₄ | Li_{2.7}Ti_{0.3}Al_{0.7}F₆ | Li—Y—Br—Cl | 104 | 82 | 4.36 | 1414 |
| Example 4 | LiNi_{0.5}Mn_{1.5}O₄ | Li_{2.7}Ti_{0.3}Al_{0.7}F₆ | Li—P—S—Cl | 116 | 92 | 4.51 | 13.5 |
| Reference | LiNi_{0.5}Mn_{1.5}O₄ | — | Li—Ta—Cl—O | 31 | 24 | 4.07 | — |
| Example 1 | | | | | | | |
| Reference | LiNi_{0.5}Mn_{1.5}O₄ | — | Li—Y—Cl | 23 | 15 | 3.71 | — |
| Example 2 | | | | | | | |
| Reference | LiNi_{0.5}Mn_{1.5}O₄ | — | Li—Y—Br—Cl | 0.97 | 0.058 | 3.42 | — |
| Example 3 | | | | | | | |
| Reference | LiNi_{0.5}Mn_{1.5}O₄ | — | Li—Ti—Al—F | 45 | 23 | 4.30 | — |
| Example 4 | | | | | | | |
| Reference | LiNi_{0.5}Mn_{1.5}O₄ | — | Li—P—S—Cl | 38 | 6.8 | 3.83 | — |
| Example 5 | | | | | | | |

In Table 1, the capacity ratio coating/non-coating for Example 1 represents the ratio of the discharge capacity of Example 1 to the discharge capacity of Reference Example 1. The capacity ratio coating/non-coating for Example 2 represents the ratio of the discharge capacity of Example 2 to the discharge capacity of Reference Example 2. The capacity ratio coating/non-coating for Example 3 represents the ratio of the discharge capacity of Example 3 to the discharge capacity of Reference Example 3. The capacity ratio coating/non-coating for Example 4 represents the ratio of the discharge capacity of Example 4 to the discharge capacity of Reference Example 5.

As shown in Table 1, coating the surface of the positive electrode active material with the first solid electrolyte material enhances the charge and discharge capacity.

The present disclosure enhances the charge and discharge capacity of the battery.

### INDUSTRIAL APPLICABILITY

The battery of the present disclosure can be used as, for example, an all-solid-state lithium-ion secondary battery.

What is claimed is:

1. A positive electrode material comprising:
a positive electrode active material;
a first solid electrolyte material coating at least partially a surface of the positive electrode active material; and
a second electrolyte material, wherein
the positive electrode active material includes an oxide consisting of Li, Ni, Mn, and O,
the first solid electrolyte material includes Li, Ti, M1, and F, and
the M1 is at least one selected from the group consisting of Ca, Mg, Al, Y, and Zr.

2. The positive electrode material according to claim 1, wherein
the positive electrode active material includes a material represented by the following composition formula (1)
LiNiₓMn₂₋ₓO₄ Formula (1), and
the composition formula (1) satisfies 0<x<2.

3. The positive electrode material according to claim 2, wherein
the composition formula (1) satisfies 0<x<1.

4. The positive electrode material according to claim 3, wherein
the composition formula (1) satisfies x=0.5.

5. The positive electrode material according to claim 1, wherein
the first solid electrolyte material consists of Li, Ti, M1, and F.

6. The positive electrode material according to claim 1, wherein
the first solid electrolyte material includes a material represented by the following composition formula (2B)
Li_{6-(4-a)b}(Ti₁₋ₐM1ₐ)_{b}F₆ Formula (2B), and
the composition formula (2B) satisfies 0<a<1 and 0<b≤1.5.

7. The positive electrode material according to claim 1, wherein
the M1 is Al.

8. The positive electrode material according to claim 1, wherein
the second electrolyte material includes:
Li;
at least one selected from the group consisting of metalloid elements and metal elements except Li; and
at least one selected from the group consisting of Cl and Br.

9. The positive electrode material according to claim 8, wherein
the second electrolyte material includes a material represented by the following composition formula (3)
Li_{α3}M2_{β3}X_{γ3}O_{δ3} Formula (3),
where α3, β3, and γ3 are each a value greater than 0, and δ3 is a value equal to or greater than 0,
M2 is at least one selected from the group consisting of metalloid elements and metal elements except Li, and
X is at least one selected from the group consisting of Cl and Br.

10. The positive electrode material according to claim 9, wherein
the M2 includes at least one selected from the group consisting of Y and Ta.

11. The positive electrode material according to claim 9, wherein
the composition formula (3) satisfies:
1≤α3≤4;
0<β3≤2;
3≤γ3<7; and
0≤δ3≤2.

12. The positive electrode material according to claim 1, wherein
the second electrolyte material includes a sulfide solid electrolyte.

13. The positive electrode material according to claim 12, wherein
the sulfide solid electrolyte is Li₆PS₅Cl.

14. The positive electrode material according to claim 1, wherein
the first solid electrolyte material is provided between the positive electrode active material and the second electrolyte material.

15. A battery comprising:
a positive electrode;
a negative electrode; and
an electrolyte layer positioned between the positive electrode and the negative electrode, wherein
the positive electrode includes the positive electrode material according to claim 1.

16. The battery according to claim 15, wherein
the electrolyte layer includes a first electrolyte layer and a second electrolyte layer, and
the first electrolyte layer is in contact with the positive electrode, and the second electrolyte layer is in contact with the negative electrode.

17. The battery according to claim 16, wherein
the first electrolyte layer includes a material having the same composition as composition of the first solid electrolyte material.

18. The battery according to claim 16, wherein
the first electrolyte layer includes a material having the same composition as composition of the second electrolyte material.

19. The battery according to claim 16, wherein
the second electrolyte layer includes a material having composition different from composition of the first solid electrolyte material.

20. The battery according to claim 15, wherein
the electrolyte layer includes a halide solid electrolyte.
